(19) United States
(12) Patent Application Publication
(10) Pub. No.: US 2019/0037856 A1
(43) Pub. Date: Feb. 7, 2019

(54) Electrostatic Oiler with Actuation Valve

(71) Applicant: Burford Corporation, Maysville, OK (US)

(72) Inventor: Robert Mackey, Mannford, OK (US)

(73) Assignee: Burford Corporation, Maysville, OK (US)

(21) Appl. No.: 16/052,787

(22) Filed: Aug. 2, 2018

Related U.S. Application Data
(60) Provisional application No. 62/540,482, filed on Aug. 2, 2017.

(51) Int. Cl. A21B 3/16; B05B 5/025; B05B 5/16; B05B 5/08

(52) U.S. Cl. CPC A21B 3/16; B05B 5/084; B05B 5/16; B05B 5/0255

(57) ABSTRACT

A pan oiler for depositing cooking oil into product molds of a baking pan includes a conveyor assembly configured to carry the baking pan through the pan oiler and an electrostatic oiler assembly. The electrostatic oiler assembly includes at least one injector assembly, a charge assembly and an oil delivery assembly. The injector assembly may include a valve body, an oil reservoir within the valve body, a valve seat within the valve body in fluid communication with the oil reservoir, a plunger extending into the valve body and an actuator operably connected to the plunger to lift the plunger off the valve seat when the actuator is energized. The plunger is retractable and conductive and in electrical contact with the charge assembly.

### RELATED APPLICATIONS

The present application claims the benefit of U.S. Provisional Patent Application Ser. No. 62/540,482 filed Aug. 2, 2017 entitled “Electrostatic Oiler with Actuation Valve,” the entire disclosure of which is herein incorporated by reference.

### FIELD OF THE INVENTION

The present invention generally relates to equipment used in the baking industry and more particularly, but not by way of limitation, to equipment configured to apply cooking oil into bakery pans.

### BACKGROUND OF THE INVENTION

For many years, commercial bakeries have utilized assembly-line production to prepare and bake products. In many cases, baked goods are prepared by placing pans onto the assembly line, loading dough into the pans and moving the pans and dough through preparation, cooking and packaging processes. Commercial baking pans often include multiple rows of molds used to hold the dough. For many products, it is desirable to apply cooking oil to the pans before the dough is placed into the pans.

In the past, automated pan oilers have used spray nozzles to disperse atomized oil onto the bakery pans. Although this approach is effective at coating the pans, the atomized oil tends to drift during the application process, which results in oil being deposited on nearby equipment and personnel. There is, therefore, a need for an improved pan oiler that overcomes these deficiencies in the prior art. It is to this and other deficiencies in the prior art that the preferred embodiments are directed.

### SUMMARY OF THE INVENTION

In one aspect, the present invention provides an electrostatic oiler assembly configured to accurately deposit a fluid within a product mold of a baking pan. The electrostatic oiler assembly includes a charge assembly, an oil delivery assembly, and at least one injector assembly connected to the charge assembly and the oil delivery assembly. The at least one injector assembly comprises means for selectively releasing positively charged and pressurized cooking oil above the product mold.

In another aspect, the present invention includes a pan oiler for depositing cooking oil into a baking pan that has at least one product mold. The pan oiler has a conveyor assembly configured to carry the baking pan through the pan oiler and an electrostatic oiler assembly. The electrostatic oiler assembly includes a charge assembly, an oil delivery assembly, and at least one injector assembly. The at least one injector assembly comprises a valve body and a plunger extending into the valve body. The plunger is retractable, conductive and in electrical contact with the charge assembly. The injector assembly further includes an actuator operably connected to the plunger to lift the plunger when the actuator is energized.

### BRIEF DESCRIPTION OF THE DRAWINGS

FIG. 1 presents a front perspective view of a pan oiler constructed in accordance with a preferred embodiment.

FIG. 2 presents a side view of the pan oiler of FIG. 1.

FIG. 3 presents a bottom view of the pan oiler of FIG. 1.

FIG. 4 presents an end view of the pan oiler of FIG. 1.

FIG. 5 presents a close-up view of the pan oiler depositing oil into the molds of a bakery pan.

FIG. 6 presents a perspective view of the electrostatic oiler assembly of the pan oiler of FIG. 1.

FIG. 7 presents a perspective view of the injector assembly of the electrostatic oiler assembly of FIG. 6.

FIG. 8 presents a front view of the injector assembly of the electrostatic oiler assembly of FIG. 6.

FIG. 9 presents a cross-sectional view of the injector assembly of the electrostatic oiler assembly of FIG. 6

### WRITTEN DESCRIPTION

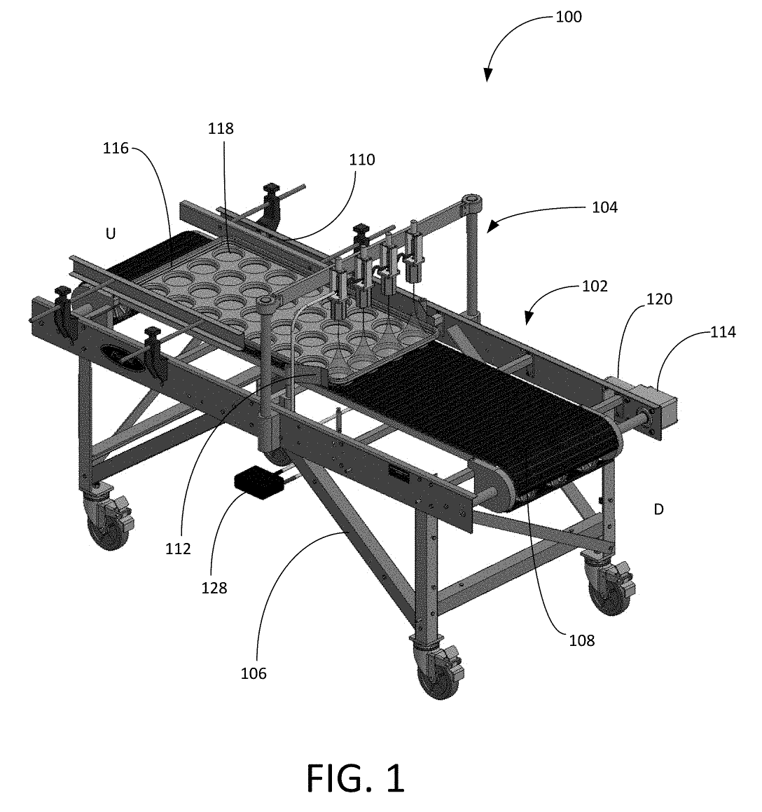

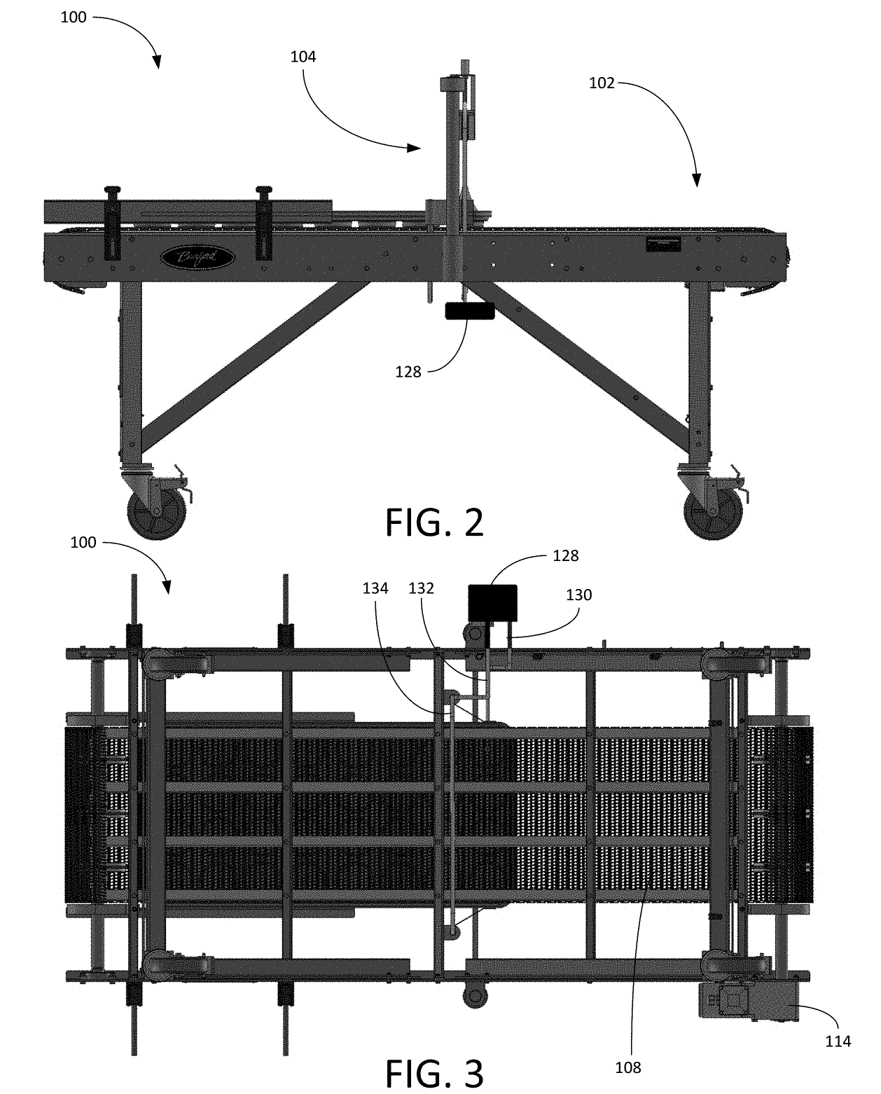

Referring to FIGS. 1-4, shown therein are perspective, side, bottom and end views, respectively, of a pan oiler 100 constructed in accordance with preferred embodiments. The pan oiler 100 is configured to be connected within a larger mechanized baking operation in which dough loafs are carried to the pan oiler 100 on a feed conveyor (not shown). As explained herein, the pan oiler 100 is configured to accurately deposit cooking oil into the molds of baking pans passing through the pan oiler 100. For purposes of this disclosure, the pan oiler 100 will be understood to have an upstream end (“U”) and a downstream end (“D”) that are relatively defined by the motion of products through the pan oiler 100.

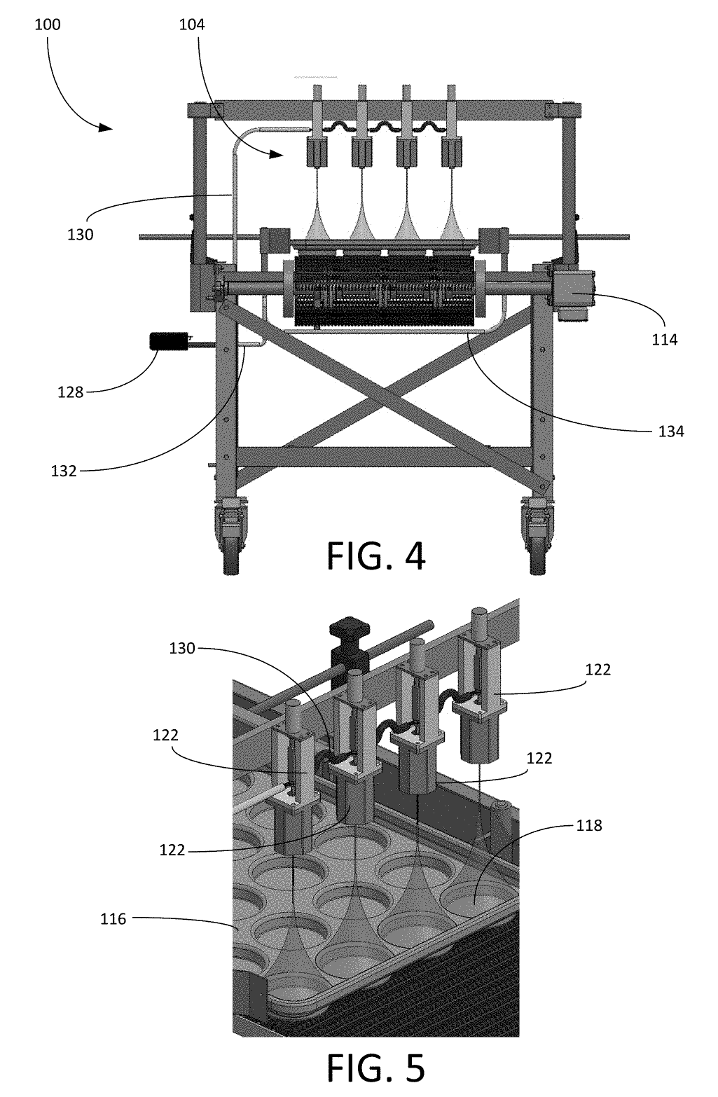

The pan oiler 100 includes a conveyor assembly 102 and an electrostatic oiler assembly 104. The conveyor assembly 102 includes a frame 106, a motorized conveyor 108, guide rails 110 and pan detectors 112. The frame 106 can be mounted in a fixed position within the bakery or placed on wheels (as shown in FIG. 1). The conveyor 108 is driven by a motor 114 (best seen in FIGS. 3 and 4). The motor 114 turns the conveyor 108, which is configured to carry a baking pan 116 that includes a series of product molds 118 arranged in a series of rows. Guide rails 110 center the baking on the conveyor 108 as it proceeds through the pan oiler 100.

The pan detectors 112 detect the position of the baking pan as it approaches the electrostatic oiler assembly 104. The pan detectors 112 can be optical, mechanical (as shown), magnetic or any other proximity-detecting technology. The speed of the approaching baking pan 116 can be directly determined using a plurality of pan detectors 112 at varying locations along the path of the conveyor 108, or indirectly determined based on the speed of the motor 114. The measurements made by the pan detectors 112 and the output of the motor 114 are presented to a control module 120 that coordinates the functions of the conveyor assembly 102, electrostatic oiler assembly 104 and the remaining components within the pan oiler 100. In certain applications, the control module 120 communicates with other automated systems within the bakery that are upstream and downstream from the pan oiler 100.

The electrostatic oiler assembly 104 can be secured to the frame 106 (as shown) or supported by a structure that is independent from the conveyor assembly 102. The electrostatic oiler assembly 104 includes one or more injector assemblies 122, a charge assembly 124, and an oil delivery assembly 126. As described below and as depicted in FIG. 5, the electrostatic oiler assembly 104 generally deposits cooking oil into the product molds 118 of the baking pan 116 with a targeting system that makes use of electrostatic attraction between positively charged droplets of cooking oil and the negatively (grounded) product molds 118 within the baking pan 116.

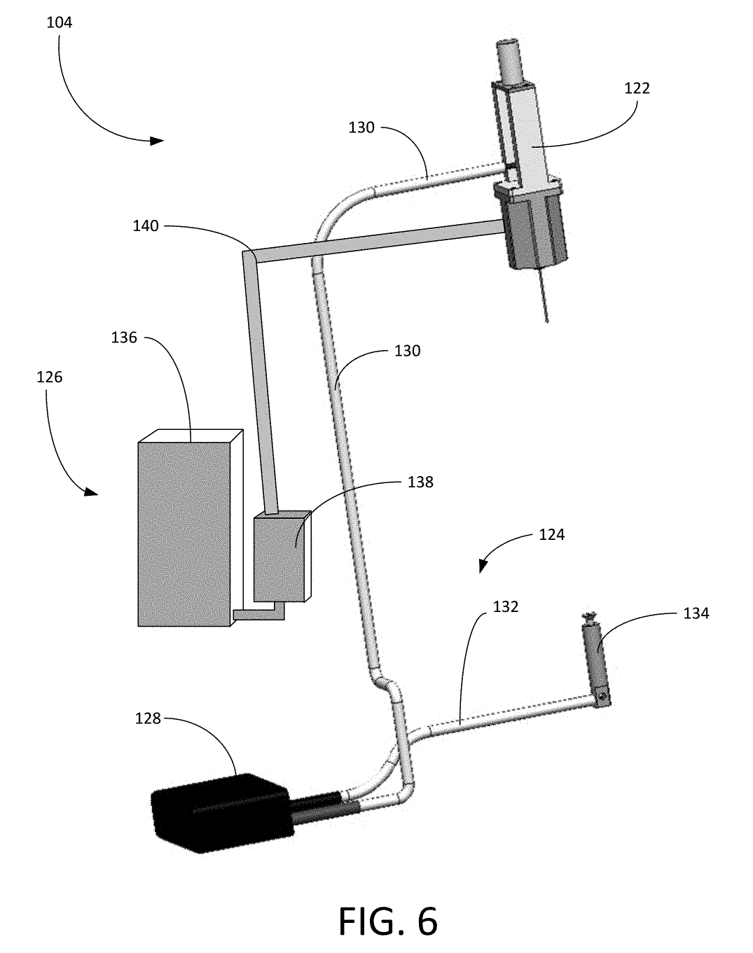

Turning to FIG. 6, shown therein is a perspective view of an electrostatic oiler assembly 104 that includes a single injector assembly 122, the charge assembly 124 and the oil delivery system 126. It will be appreciated that the electrostatic oiler assembly 104 may include multiple injector assemblies 122 (four are shown in FIGS. 1-5) and further that the pan oiler 100 may include multiple electrostatic oiler assemblies 104. For example, in some embodiments, multiple electrostatic oiler assemblies 104 are deployed along the conveyor assembly 102, with each electrostatic oiler assembly 104 including individual injector assemblies 122 that correspond to the number of product molds 118 in each row of the baking pan 116.

The charge assembly 124 includes an amplified power source 128, a positive lead 130 connected between the power source 128 and the injector assembly 122 and a negative lead 132 connected between the power source 128 and a ground contact 134. In some embodiments, the power source 128 is configured to produce about 50,000 volts of electricity. As best seen in FIG. 3, the ground contact 134 is retained below the conveyor 108 in electrical contact with the bottom of the baking pan 116. It will be noted that the baking pan 116 is constructed from a material that conducts electricity, such as steel, copper or conductive metal alloys. In some embodiments the baking pan 116 includes insulating partitions that electrically isolate some product molds 118 from other product molds 118.

The oil delivery system 126 includes a cooking oil tank 136, a pump 138 and tubing 140 that extends from the pump 138 to the one or more injector assemblies 122. The pump 138 pressurizes the cooking oil and delivers the oil to the injector assembly 122. In exemplary embodiments, the cooking oil is an emulsified edible cooking oil that exhibits favorable dispersion and coating characteristics. Suitable cooking oils include blends of mineral oil, soy oil and lecithin. The pump 138 is configured to maintain a delivery pressure on the cooking oil of between about 0.5 pounds-per-square-inch (psi) and about 30 psi. In exemplary embodiments, the cooking oil is supplied to the injector assembly 122 from about 2 to about 3 psi.

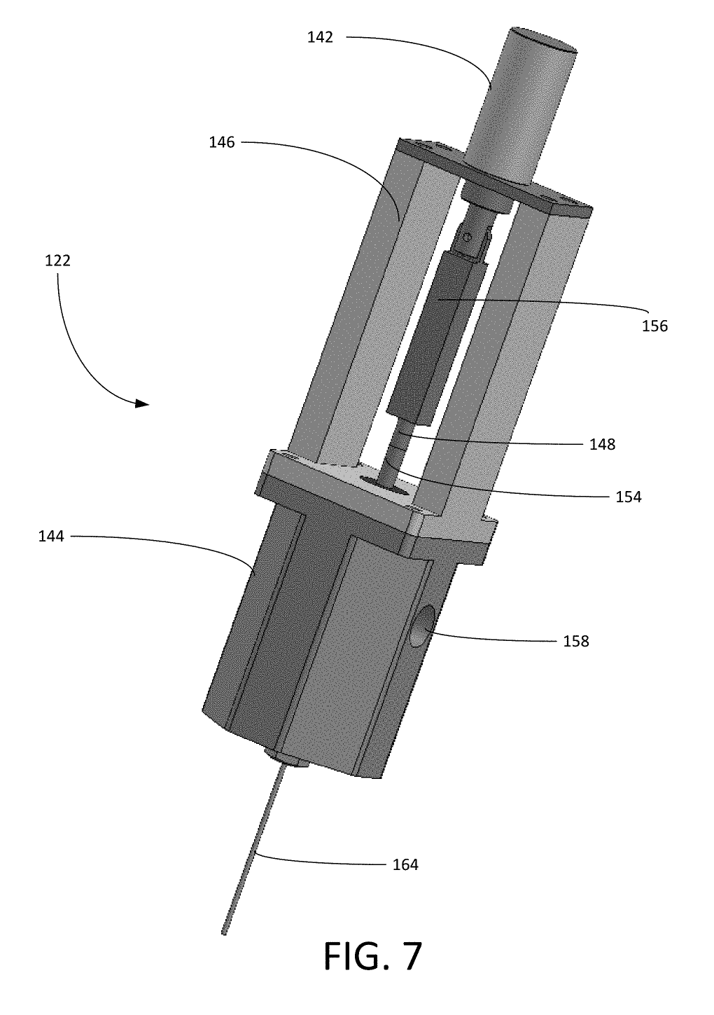

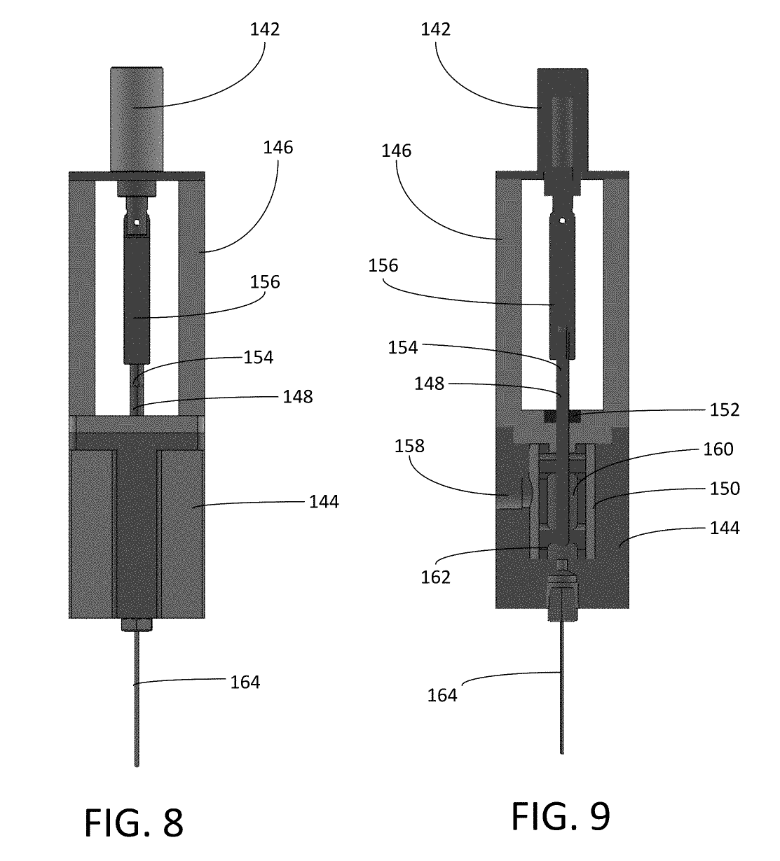

Turning to FIGS. 7-9, shown therein a perspective, front and cross-sectional views, respectively, of the injector assembly 122 from FIG. 6. The injector assembly includes an actuator 142, a valve body 144 and a stand-off 146. The stand-off 146 separates and supports the actuator 142 from the valve body 144. In exemplary embodiments, the actuator 142 is an electrically-activated solenoid that produces a linear retraction when energized. In other embodiments, the actuator 142 is a pneumatic piston or an actuator that exhibits a piezoelectric movement in response to an electric charge or control signal.

The injector assembly 122 includes a conductive plunger 148 that extends into a reservoir 150 in the valve body 144 through a seal 152. The valve body 144 and seal 152 are manufactured from electrically insulating materials. The plunger 148 includes a positive contact 154 to which the positive lead 130 of the charge assembly is connected. The positive lead 130 is connected to the positive contact 154 with a clip or slide that allows the positive lead 130 to stay in contact with the positive contact 154 during the operation of the injector assembly 122.

An isolator 156 connects the plunger 148 to the actuator 142. The charge applied to the conductive plunger 148 is carried to the cooking oil in the reservoir 150, but not to the actuator 142. In this way, a positive charge can be applied to the cooking oil in the reservoir 150 through the positive lead 130, positive contact 154 and the plunger 148.

The reservoir 150 is connected to the tubing 140 through an inlet port 158. The pump 138 fills the reservoir 150 with cooking oil under a selected pressure. The plunger 148 extends through a return spring 160 that is captured within the valve body 144. The plunger 148 terminates in a valve seat 162, which is connected to a deposition needle 164. The deposition needle 164 may be hollow or solid. In exemplary embodiments, the deposition needle 164 can be quickly removed from the valve body 144 to permit the interchangeable use of deposition needles 164 that exhibit varying flow profiles.

The return spring 160 holds the plunger 148 against the valve seat 162 to prohibit oil inside the reservoir 150 from being pushed into the deposition needle 164. When the actuator 142 is activated and retracts the plunger 148, the plunger 148 lifts off the valve seat 162 against the force of the return spring 160 to temporarily open the valve seat 162. A volume of cooking oil exits the reservoir 150 until the actuator 142 is released and the return spring 160 forces the plunger 148 into a closed position in the valve seat 162. The volume of cooking oil expelled from the injector assembly 122 can be adjusted by changing the size of the deposition needle 164, the actuation time of the actuator 142 and the pressure of the cooking oil in the reservoir 122. It will be noted that the travel of the plunger 148 is relatively small such that the valve seat 162 can be rapidly opened and closed.

During use, the pan oiler 100 produces a dispersion of cooking oil that is guided into specific product molds 118 of the baking pan 116 through electrostatic attraction. When the baking pan 116 approaches the electrostatic oiler assembly 104, the charge assembly 124 supplies a positive charge to cooking oil contained within the reservoirs 150 of one or more injector assemblies 122. In some embodiments, the charge assembly 124 maintains a constant charge, while in other embodiments the cooking oil in the reservoir is only temporarily charged before it is expelled from the injector assembly.

As the baking pan 116 continues to move along the conveyor 108, the actuator 142 is activated and retracts the plunger 148 from the valve seat 162. The pressurized, positively-charged cooking oil is forced from the valve body 144 through the deposition needle 164. Once ejected from the valve body 144 and deposition needle 164, the cooking oil rapidly disperses into small positively-charged droplets. As the droplets fall, the baking pan 116 contacts the ground contact 134 and the positively charged droplets are drawn by electrostatic attraction into the product molds 118.

The coordinated operation of the conveyor assembly 102 and electrostatic oiler assembly 104 provides an enhanced pan oiling system that overcomes many of the deficiencies in the prior art. In particular, the pan oiler 100 provides a more accurate oil coating to the baking pan 116, with less overspray and under lower fluid pressures. The injector assemblies 122 are configured to rapidly cycle to provide targeted oiling to discrete rows of product molds 118 within the baking pan 116. This level of accuracy and precision has not been achieved by prior art spraying systems.

Thus, it is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed herein and as expressed in the appended claims.

What is claimed is:

1. A pan oiler for depositing cooking oil into a baking pan that has at least one product mold, the pan oiler comprising:
a conveyor assembly configured to carry the baking pan through the pan oiler; and
an electrostatic oiler assembly, wherein the electrostatic oiler assembly comprises:
a charge assembly;
an oil delivery assembly; and
and at least one injector assembly, wherein the at least one injector assembly comprises:
a valve body;
a plunger extending into the valve body, wherein the plunger is retractable and conductive, and wherein the plunger is in electrical contact with the charge assembly; and
an actuator operably connected to the plunger to lift the plunger when the actuator is energized.

2. The pan oiler of claim 1, wherein the injector assembly further comprises an oil reservoir within the valve body, wherein the oil reservoir is in fluid communication with the oil delivery system.

3. The pan oiler of claim 2, wherein the valve body comprises a valve seat in fluid communication with the oil reservoir and wherein the actuator is configured to lift the plunger off the valve seat with the actuator is energized.

4. The pan oiler of claim 3, wherein the injector assembly further comprises a deposition needle connected to the valve body adjacent the valve seat.

5. The pan oiler of claim 1, wherein the injector assembly further comprises an isolator connected between the actuator and the plunger.

6. The pan oiler of claim 1, wherein the actuator comprises a motor selected from the group consisting of solenoids, pneumatic pistons and piezo electric devices.

7. The pan oiler of claim 1, wherein the oil delivery system comprises:
an oil tank;
tubing connected to the injector assembly; and
a pump configured to move cooking oil from the oil tank to the injector assembly under pressure.

8. The pan oiler of claim 7, wherein the pump is configured to pressurize the cooking oil to a pressure of between 0.5 psi and 30 psi.

9. The pan oiler of claim 8, wherein the pump is configured to pressurize the cooking oil to between 2 psi and 3 psi.

10. A pan oiler for depositing cooking oil into a baking pan that has a plurality of product molds arranged in one or more rows, the pan oiler comprising:
a conveyor assembly configured to carry the baking pan through the pan oiler; and
an electrostatic oiler assembly, wherein the electrostatic oiler assembly comprises:
a charge assembly;
an oil delivery assembly; and
a plurality of injector assemblies, wherein each of the plurality of injector assemblies comprises:
a valve body;
a plunger extending into the valve body, wherein the plunger is in electrical contact with the charge assembly; and
an actuator operably connected to the plunger to lift the plunger when the actuator is energized.

11. The pan oiler of claim 10, wherein each of the plurality of injector assemblies corresponds to a separate one of the plurality of product molds in a single row of the baking pan.

12. The pan oiler of claim 10, wherein the injector assembly further comprises an oil reservoir within the valve body, wherein the oil reservoir is in fluid communication with the oil delivery system.

13. The pan oiler of claim 12, wherein the valve body comprises a valve seat in fluid communication with the oil reservoir.

14. The pan oiler of claim 13, wherein the injector assembly further comprises a deposition needle connected to the valve body adjacent the valve seat.

15. The pan oiler of claim 14, wherein the deposition needle is hollow.

16. The pan oiler of claim 10, wherein the injector assembly further comprises an isolator connected between the actuator and the plunger.

17. The pan oiler of claim 10, wherein the actuator comprises a motor selected from the group consisting of solenoids, pneumatic pistons and piezo electric devices.

18. The pan oiler of claim 1, wherein the oil delivery system comprises:
an oil tank;
tubing connected to the injector assembly; and
a pump configured to move cooking oil from the oil tank to the injector assembly at a pressure of between 0.5 psi and 30 psi.

19. An electrostatic oiler assembly configured to accurately deposit a fluid within a product mold of a baking pan, wherein the electrostatic oiler assembly comprises:
a charge assembly;
an oil delivery assembly; and
at least one injector assembly connected to the charge assembly and the oil delivery assembly, wherein the at least one injector assembly comprises means for selectively releasing positively charged and pressurized cooking oil above the product mold.

20. The electrostatic oiler of claim 19, wherein the charge assembly comprises a ground contact proximate the product mold of the baking pan.
